(19) United States
(12) Patent Application Publication
(10) Pub. No.: US 2016/0171040 A1
(43) Pub. Date: Jun. 16, 2016

(54) HIERARCHICAL CROSS-LINKED PURPOSE ORIENTED DOCUMENT VALIDATION SYSTEM AND PROCESS

(71) Applicants: Nuno Gonçalo Maruny Vidal De Oliveira Martins, Carnaxide (PT); Daniel Filipe Fernandes Carvalho de Sousa Lobo, Povoa de Santa lria (PT)

(72) Inventors: Nuno Gonçalo Maruny Vidal De Oliveira Martins, Carnaxide (PT); Daniel Filipe Fernandes Carvalho de Sousa Lobo, Povoa de Santa lria (PT)

(73) Assignee: VORTAL-COMERCIO ELECTRONICO, CONSULTADORIA E MULTIMEDIA, S.A., Porto (PT)

(21) Appl. No.: 14/942,808

(22) Filed: Nov. 16, 2015

Related U.S. Application Data
(63) Continuation-in-part of application No. 13/547,882, filed on Jul. 12, 2012, now abandoned.

(30) Foreign Application Priority Data
Jul. 12, 2011 (PT) 105806

(51) Int. Cl. G06F 17/30; G06Q 10/10

(52) U.S. Cl. CPC G06F 17/30371; G06F 17/30011; G06Q 10/10

(57) ABSTRACT

System and Method or Process that validates documents in hierarchical cross-linked purpose.

The present application is a continuation-in-part of U.S. patent application Ser. No. 13/132,224, filed Jul. 12, 2012, which claims the priority benefit under 35 U.S.C. §119 of Portuguese Patent Application No. PT 105806 filed on Jul. 12, 2011, which is hereby incorporated in its entirety by reference.

### TECHNICAL FIELD OF THE INVENTION

The present invention relates to the hierarchical cross-linked validation of documents, namely the validation considering the purpose of said documents.

### GENERAL DESCRIPTION OF THE INVENTION

In complex modern purchasing procedures, namely in large-scale building, aerospace or complex systems projects, the validation of suppliers and supplies usually involves a large number of administrative, legal and regulatory documents.

Typically, it is perfectly normal that the items being put up for quotation in a tender may reach thousands in number, and hundreds, or even thousands, in type/make.

Also, depending on the tender procedure a buyer may choose to request appropriate documentation from the top-level bidders or even from all bidding levels, but in both cases, upper-level bidders may want to ensure that lower-level bidders also have obtained and made available the appropriate documents.

The documents required usually comprise one or more of the following variations:
by document purpose (what is it supposed for?)
by document type (certificate, diploma, permit, . . . )
by country (for which country must it be valid?)
by language
by issue date and/or validity period
by periodicity (is it a recurrently issued document?)
by emitter or issuer of the document
by receiver of the document (who is it for?)
by size, level and/or amount
by currency

The validation of the document fitness involves one or more, usually most, sometimes all, of these variations or dimensions.

Also, some documents may involve multiple selections for these dimensions. For example, an architect professional diploma may be issued for more than one country, as for example some countries (e.g Benelux) commonly issue and accept professional documents valid in other countries. Another example, would be a document issued in a multiplicity of languages, like an European patent which is normally issued in French/English/German. Still further, the same language can have variations according to the country of document origin, such that a German document from Austria may, or may not, be deemed validly equivalent to a German document from Switzerland.

Further, some of these dimensions are hierarchical. For example, a document may attest the maximum size, level or currency amount for which a specific building supplier is certified to operate. A document issued for a certain level will usually, but not always, encompass the lower levels. This obviously may happen for a specific country or countries, language, etc. . . . . For example, a type I building permit may encompass a type IIa building permit and a type IIb building permit. The same may happen in contractor various certifications or other dimensions. Alternatively or additionally, one or more documents issued for a specific country(ies)/specific purpose(s) may be replaced by an equivalent document which encompasses all said country(ies) and purpose(s). Another may be country or geographical scope of the document—for example, a document may be issued for the whole of the European Union, which encompasses all countries within it. Or alternatively, a document issued for the whole of the European Union can be considered valid for the Benelux countries, and thus valid for each of Belgium, Netherlands, Luxemburg.

This validation procedure is improved if a machine can read the data inside a PDF file in a simpler way. The present application discloses an embodiment of a process of hierarchical cross-linked purpose validating of documents in a system, where the step of selecting one or more document templates by associating said one or more document templates from the buyer with a specific purchasing process, comprises the step:
retrieving information from at least one PDF file comprising a structured character string represented with a font color equal to the background.

The objective is to be able to, through a transformation process, generate a PDF with the required information that allows us to reverse that transformation and make it structured again. Said structured information represents the fields required by the templates, and links between templates, in order to make them importable to or exportable from the system. This thus allows to perform a validation step when loading a document, such as validating a date, fiscal numbers, etc.

This solution makes use of structured content added to a PDF with the same font color as the background, so it will not be readable by humans. Although it is possible to collect that markup with the “copy and paste” action, it will not be viewable when read or printed.

Hence, it is possible to embed information in a PDF file in order to revert the information back to a structured information with the minimum impact to the presentation of the PDF.

In another embodiment, the structured character string is represented with a font height of at most 3 points. This feature allows minimizing the interference created in the mouse cursor selectable space and making any markup imperceptible.

In a further embodiment, the structured character string is placed in the beginning of the PDF file content.

In a document as a PDF, the main objective is to be understandable by humans, the machine readable fields are the ones that have to adjust to the content of the document and not the other way around as it is normally for machine readable formats.

When adding machine readable fields into a PDF file, it is important that these do not collide with the information of the document. This leads to two types of information: content, to be understood by humans; and structure, to be perceived by machines. These two types of information are exclusive and cannot be mixed. A human should not read Structure, a machine should not read Content.

In one embodiment, the structured character string implements a tree structure and comprises at least one node label replacement. This allows avoiding the collision problem, by recognizing each of the replaced node labels with a different label, which does not interferes with the PDF content.

In another embodiment, the root node comprises an attribute with the at least one node label replacement.

The cross-linking consists in recognizing that a specific document may have an equivalent document in another country, language, time period, etc. . . . . This allows the system to assist users in establishing easy document transfers across countries, languages, etc. . . . . For example, a company may have uploaded and validated a set of documents for a specific purpose in a first country. When preparing a similar set of documents for a second country, the system is then able to recognize which documents may be able to be directly transferred as they are valid in this second country and which documents will need to be obtained or reissued for this second country. The verification must take into account the multiple selections or hierarchical relationships. This may happen across any of the dimensions previously discussed.

Preferably, the verification for which dimensions, respective values and hierarchical levels for which a document is valid should happen when the document is uploaded, so that the transfer referred above is actually unnecessary as the document already spans the dimensions, respective values and levels, for which it is valid. This obviously may be updated as needed, but the concept involves classifying a document as fully as possible so that the document initially spans every possible validity area. Alternatively, documents may be uploaded individually or in bulk, and then subsequently classified.

A preferable feature consists in establishing a template for a document group. This template may specify a number of documents, each template being specified for a number of the dimensions previously mentioned. The template, contrary to a document group, is not a container and will not contain individual documents, merely the specification of the need of such documents. The template can be matched against one or more documents, denoting which documents match the template requirements (one, several, none). Such a template will typically be produced with a significant linkage—a set of documents for a generic purpose for a specific country, or for a specific purpose for multiple countries, or similar frameworks. For example, a document template may match specific documents needed to bid for building a bridge in France, or for inspecting an electricity contractor across all European countries, or for certifying documentation for a number of different languages. Optionally, a template will not contain highly specific dimension data such as dates or user details, enabling its reuse.

A set of templates, or interchangeably, administrative document templates (ADT), may be stored in an document folder, or interchangeably, an administrative document folder (ADF).

Optionally, a template can be modified, whether by modifying a copy of the original template or by modifying the original template. Optionally, a template can be easily modified, or a copy of the template can be easily modified, in its date fields, such that a previously used template can be re-used, in particular in a new bidding process, updating its date fields, such that, for example, validity requirements for documents can be checked against the new procedure dates and not against the old procedure dates.

### DESCRIPTION OF THE FIGURES

The following figures provide preferred embodiments for illustrating the description and should not be seen as limiting the scope of invention.

FIG. 1 describes an embodiment with a typical hierarchical purchasing process where a buyer 10 issues a Request for Quote A 12 based on an Opportunity Dossier A 12 to one or more 1st level bidders, for example a specific 1st level bidder 20.

FIG. 2 shows an embodiment where a buyer 10 specifies, a document template A 13 which in turn specifies one or more document(s) the buyer 10 requires for accepting bids in the purchasing process.

FIG. 3 shows a representative structure of a document template, comprising a number of dimensions 110, 120, 130 relevant to the template 100.

FIG. 4 shows a specific example in which the dimensions are especially hierarchical, wherein its dimension instances are specified at any one of a plurality of levels in each dimension.

FIG. 5 shows how two dimensions can be linked by a crosslink 150 data structure such that two dimension instances are deemed equivalent.

FIG. 6 shows how such a cross-link 150 may connect instances of the same dimension, or for that matter, different dimensions at any hierarchical level.

FIG. 7 shows a document data structure is matched 310, 320, 330 against a document template, at each of their respective dimensions.

FIG. 8 shows a specific document template example in which hierarchies are not shown for clarity purposes.

FIG. 9 shows a specific document template example in which all template data, e.g. purpose or receiving entity, is coded as dimensions, thus enabling a more generic approach, whereby any document can be matched to any template, provided their dimension instances match.

FIG. 10 shows how the template dimension hierarchy can code different requisite levels, e.g. a supplier level of adequacy, such as a building permit level.

FIG. 11 shows a general procedure for an embodiment, wherein a template folder—Administrative Document Folder ADF is created for each country, said folder containing document templates—Administrative Document Template ADT. A buyer specifies, as part of the creation of the procedure request, what document templates are required making use of the previously built template folder for the country in which the procedure is to be requested. A bidder (or supplier) will subscribe to the document folders for the countries in which the bidder is interested, so that the system can check for the compliance of the relevant documents by making use of the document templates of said document folders. If the existing document matches an already existing template, then it can be automatically added to the procedure. If an existing document matches the template, but is no longer valid or will soon be no longer valid, then an appropriate alert is produced. If uploaded documents do not match any template, then these are added to a generic template as this helps classifying and retrieving those documents. Optionally, mismatches may be accepted if there is a minimum level of matching between template and document. This level may be customizable.

FIG. 12 shows a folder (or dossier) management screen.

FIG. 13 shows a template management screen.

FIG. 14 shows a template editing screen.

FIG. 15 shows a template editing screen in which the companies it applies to are indicated: national or foreign companies; companies individual countries (multiple selections are possible). The parameter fields are customizable for each template and may indicated as optional or mandatory, and are of different customizable data types.

FIG. 16 shows an individual document editing screen.

FIG. 17 shows an individual document editing screen.

FIG. 18 shows how the buyer may specify the templates applicable to a specific procedure. Note how a template which has validity can be directly specified as to what is the validity period required for the procedure.

FIG. 19 shows the system matching the document of FIG. 17, for example if it was previously uploaded, to the requisite templates of FIG. 18. A missing document is alerted to the user. The system may also allow that documents are digitally signed at this stage.

FIG. 20 shows the overall screen and program flow between the various actions described.

FIG. 21 shows how a bidder may choose (subscribe) a number of folders (dossiers) to follow, such that the system will continuously verify and alert for any mismatch or validity issue with the bidder documents.

FIG. 22 shows a screen for making the connection between equivalent templates of different countries, one example of cross-linking templates.

FIG. 23 shows a screen where a document is uploaded. Note the same document may contain a plurality of ‘blurbs’ or digital containers, for example a digital image of the document, a digital signature of the document, a digital image of the paper certification of the paper document, etc.

FIG. 24 shows a visualization screen corresponding to the screen of FIG. 23.

FIGS. 25-27 show administrative and maintenance screens, for further specifying document details.

In the figures, the various elements are such that:
(1) represents the creation of an administrative document folder ADF for receiving document templates;
(2) represents adding administrative document templates ADT to said administrative document folders 1;
(3) represents subscribing administrative document folders ADF which are of interest to the current buying procedure;
(4) represents adding or filling in the documents corresponding to each administrative document template ADT;
(5) represents defining the required administrative document templates ADTs from the appropriate administrative document folder ADF;
(6) represents the reply to the procedure request;
(10) represents a top-level buyer,
(11) represents an opportunity dossier A by the top-level buyer 10,
(12) represents request for quote (RFQ) for the opportunity dossier A 11 by the top-level buyer 10,
(20) represents a 1st level bidder,
(21) represents an opportunity dossier A1 by the 1st level bidder 20,
(22) represents a request for quote (RFQ) for dossier A1 21 by the 1st level bidder 20,
(30) represents a 2nd level bidder;
(13) represents a document template A,
(24) represents a document A which may match template A 13,
(23) represents a template A1,
(25) represents a matching between template document A 13 and document A 24,
(34) represents a document A1 which may match the document template A1 23,
(35) represents a matching between document template A1 23 and document A1 34,
(100) represents the document template,
(110) represents a dimension X of a document template,
(120) represents a dimension Y of a document template,
(130) represents a dimension Z of a document template,
(101) represents a specific document template,
(111) represents a dimension country of a document template,
(121) represents a dimension language of a document template,
(131) represents a dimension kind of a document template,
(111a-b) represents a dimension country instance,
(121a-b) represents a dimension language instance,
(131a-b) represents a dimension kind instance,
(150) represents a cross-link between dimension instances of a specific document template,
(310, 320, 330) matching between template (100) and document (200),
(102) represents a specific document template,
(141) represents a dimension type of a document template,
(151) represents a dimension purpose of a document template,
(141a) represents a dimension type instance,
(151a) represents a dimension purpose instance,
(103) represents a specific document template,
(161) represents a receiver entity dimension of a document template,
(171) represents a process stage dimension of a document template,
(161a) represents a receiver entity dimension instance,
(171a) represents a process stage dimension instance,
(181) represents a supplier level dimension of a document template,
(181a-c) represents a supplier level dimension instance.

### DESCRIPTION OF EMBODIMENTS

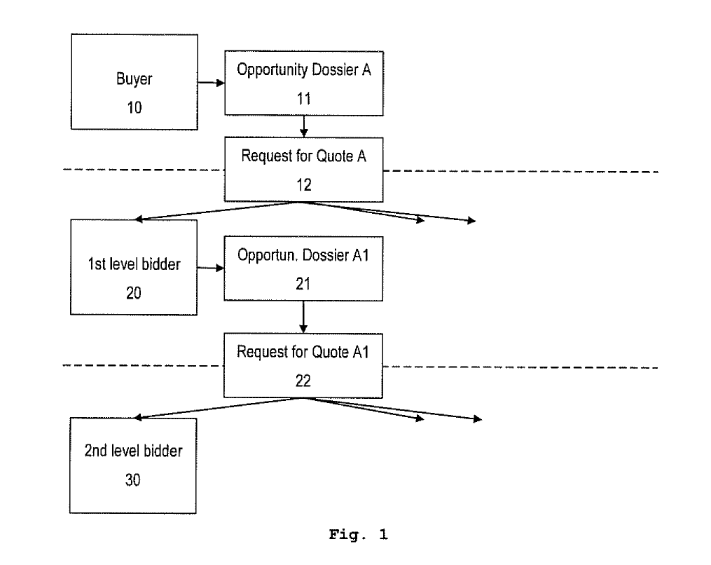

FIG. 1 describes an embodiment with a typical hierarchical purchasing process where a buyer 10 issues a Request for Quote A 12 based on an Opportunity Dossier A 12 to one or more 1^{st} level bidders, for example a specific 1^{st} level bidder 20. The 1^{st} level bidder 20 then issues a Request for Quote A1 21 based on a Opportunity Dossier A1 21 to one or more 2^{nd} level bidders, for example a specific 2^{nd} level bidder 30. The process is highly hierarchical and multiple levels are common, almost mandatory, for efficient estimating and competitive prices. The number of levels has no a priori limits and, in particular cases, may simply be a single level comprising just a buyer and a bidder, but will mostly vary with the complexity and size of the purchase.

Typically, a template will be established by a higher level system operator, in particular the topmost buyer. These templates will normally specify the documents needed for most common purchasing operations. Bidders are then able to select from these templates which is/are most appropriate and, if necessary, customize. Bidders will then be able to upload documents fitting into this template so that compliance can be verified. Alternatively or additionally, the buyer may predefine one or more document templates for a bidding process. The buyer may define how and by how much can this compliance be measured against the template.

Preferably, as mentioned above, the documents may be initially or subsequently classified into all validity areas so that when a bidder applies for a specific bidding opportunity, the system will be able to automatically match previously uploaded documents with the current bidding template. In this way, the system is able to inform the supplier of any missing document for compliance with the template. Preferably, the system may alert the supplier if there is a relatively minor validity shortcoming as, for example, a required document which is no longer valid requiring a revalidation or reissue, or for example, a required document which valid for a lower level bid requiring an upgrade to next higher level. This is easily done by comparing the multidimensional distance between the items in the bidding template and in the uploaded supplier documents.

In particular, dimensions can be classified according to relevance for this matching process, for example by the buyer generally or for each bidding procedure, or by a system operator. For example, in a typical embodiment, the date field will usually be given a low relevance, such that a document with a date mismatch against the requisite template will be easily “almost”-matched and thus suggested to the user. In some embodiments, the system may alert for the specific mismatches detected. To illustrate with an example, the user in the case of a date mismatch will then be alerted that a similar document but with a new date should be obtained, by e.g. revalidation or reissue of the existing document. For example, in a typical embodiment, the document type field will usually be given a high relevance, such that a document with document type mismatch against the requisite template will not be easily suggested as promising starting point for obtaining a valid document fulfilling the template requisites.

Even if documents are not initially classified, as buyers will submit these documents to specific bidding templates, the system will be incrementally aware of the validity areas of these documents, as they are accepted by different buyers. Preferably, the system may use a known technique for validating documents based on the number and type of buyers, or upper-level bidders, that have accepted a document—establishing a score, social network rankings, etc. . . . —and then creating a template expressing this ‘de-facto’ approval. In this way, the system is, as above, able to inform the supplier of any missing document for compliance with the template and check which documents are already available and verified for a new bid. Preferably, the system may also, as above, alert the supplier if there is a relatively minor validity shortcoming.

Other optional features which are also preferable consist namely in managing the users and organizations/companies responsible and/or allowed for the document upload, use, and validation by adequate system permissions. Other optional features which are also preferable consist namely in managing the users and organizations/companies responsible and/or allowed for the template upload, use, and validation by adequate system permissions.

Furthermore, a bidder at a specific level in the bidding process may specify which template or templates are required from lower-level bidders in order to match the requisites from the buyer, or an upper-level bidder. In this case, when a buyer, or upper-level bidder, specifies a template, the system may automatically suggest the previously linked templates to the bidder. Alternatively, the system may suggest these templates by simply analyzing the most used templates in previous purchase/bidding processes in connection with the template form the buyer, or upper-level bidder.

Preferably, the user or users of a document, namely the issuer or issuers, the validation issuer or issuers, of said document may incorporate a digital signature onto a document or documents, when uploading or also subsequently. This is synergetic with the multi-level hierarchical document structure already described, as the user permissions and authorizations may also be stored using this structure, namely digital signatures.

Also, preferably, the system may be used to both manage documents both in bidding and purchase fulfillment phase. Obviously, the required documents may be different, so that this aspect may preferably and optionally treated as a further dimension, representing the phase/stage/timing of the procedure.

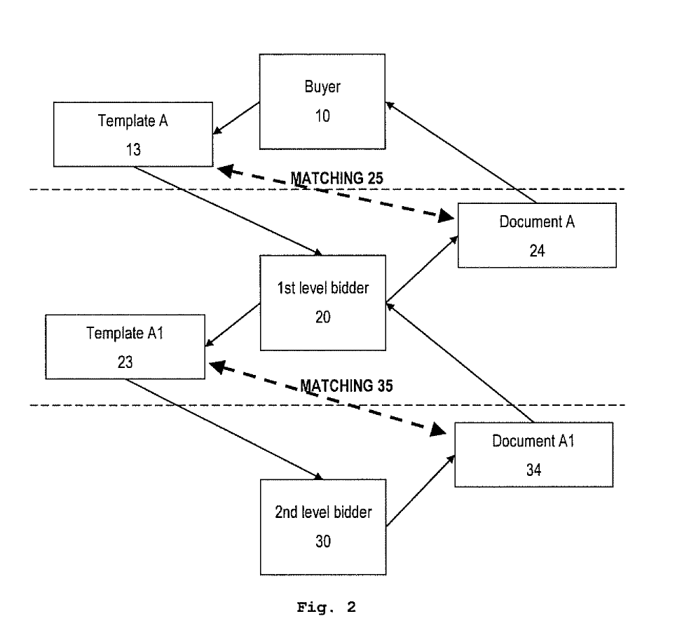

FIG. 2 shows an embodiment where a buyer 10 specifies, whether explicitly or automatically using the system, a document template A 13 which in turn specifies one or more document(s) the buyer 10 requires for accepting bids in the purchasing process. A 1^{st} level bidder 20 in turn specifies, whether explicitly or automatically using the system, a template A1 23 which in turn specifies document(s) the 1^{st} level bidder 20 requires for accepting bids in the purchasing process.

The 2^{nd} level bidder 30 may then upload or select a previously uploaded document A1 34. The selection of a previously uploaded document may be automatic by selecting one or more documents that fully or partially match the higher level template A1 23. The uploaded document A1 34 may then undergo matching 35 against the higher level template A1 23 such that it can be verified if the document complies with the requirements of the 1^{st} level bidder 20 for the purchasing process. If the verification is such that it does not comply, the 2^{nd} level bidder 30 may be given an alert and/or may be given a choice of still submitting the mismatched document, removing the document or replacing by another document.

The 1st level bidder 20 may then upload or select a previously uploaded document A 24. The selection of a previously uploaded document may be automatic by selecting one or more documents that fully or partially match the higher level template A 13. The uploaded document A 24 may undergo matching 25 against the higher level template A 13 such that it can be verified if the document complies with the requirements of the buyer 10 for the purchasing process. If the verification is such that it does not comply, the 1st level bidder 20 may be given an alert and/or may be given a choice of still submitting the mismatched document, removing the document or replacing by another document.

Optionally, the Template A1 23 may be a subset of the Template 13 A, such that the documents specified by the 1^{st} level bidder 20, while still fulfilling the requirements from the buyer 10, may add further requirements of the 1^{st} level bidder 20, specifying a smaller subset of specifications.

Optionally, the template A 13 may be linked in the system to template A1 23 such that when the template A 13 is specified, the lower level template A1 23 can be automatically specified or suggested for specification by the system.

In a purchasing process a buyer, or upper-level bidder, may specify one or more document templates, each template for each document requirement it has in connection with the purchasing process.

Optionally, a bidder may fulfill each document template specification with one document.

Optionally, a bidder may fulfill each document template specification with two or more documents. This is the case where a document will, for example, cover part of the template requirements, and another will cover the remaining part of the template requirements. For example, a contractor may prove legal ability to operate in a regional group of countries by providing a legal document for each of the countries specified. For example, in the very same purchasing process, another bidder may prove legal ability to operate in that regional group of countries by providing a legal document for the whole of the countries specified.

Optionally, the process and system described can be applied to any phase/stage/time of a purchasing, bidding or fulfillment process.

Optionally, the process and system described can be applied even if a single level of buyer/bidder exists. Even in this case,

One of advantages of the present system and method is procedural speed. It is advantageous being able to initiate large-scale multi-level purchasing processes just by selecting an appropriate template, which subsequently opens the process for bidding by multi-level hierarchically organized suppliers. The suppliers may then make use of previously classified and validated documents, whether for the same country, language, purpose, whether for slightly different or even substantially different countries, languages, etc. . . . with the system ensuring, by use of the described hierarchies and cross-linkage, that the selected documents are valid for this new bid. In highly complex procedures, spanning different countries, languages, jurisdictions, the capability of a set of suppliers to bid in due time by ensuring that all relevant documents are provided is critical. It will be easily understood that simple human verification of the linkages and hierarchical dependencies is simply unfeasible in the short time limits available. Further, as multilevel procedures are concerned, this verification, if done manually, would require the sequential verification at each level and thus wasting a significant amount of time.

One other advantage of the system and method is the reduction of duplicated effort in classifying and validating documents for each purchasing procedure, as this only now needs to be carried out once.

A dimension, or field, of a template can be validity across time, such that a document may have a end date beyond which it is no longer considered valid, or start date before which it is not yet considered valid, or both. This may be stored as explicit dates or simply represented as calendar periods as in “2012” or “Jan/2012” or “1^{st} quarter of 2012”. Optionally, these dates may comprise time of day and/or time zone information and/or calendar type (e.g. Gregorian/Arabic) information.

In an embodiment, when a buyer specifies in a template that a document is required valid for a specific date, for example a purchase date, then all documents which are valid encompassing that specific date will also be considered valid.

In an embodiment, when a buyer specifies in a template that a document is required valid for a specific period, for example the project extent period, then all documents which are valid encompassing all the specific period will also be considered valid.

A document may additionally comprise other attributes such as renewal information, e.g. renewal dates or renewal periods, relevant URL's (e.g. web addresses) as for example validation or issuer URL's, which the system may use automatically to provide, for example renewal or validation services.

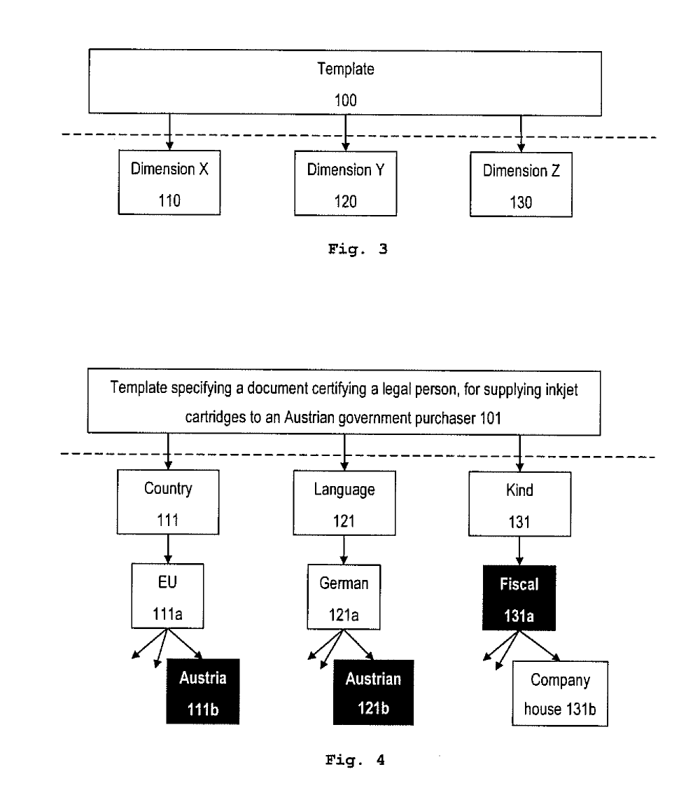

FIG. 3 shows a representative structure of a document template, comprising a number of dimensions 110, 120, 130 relevant to the template 100.

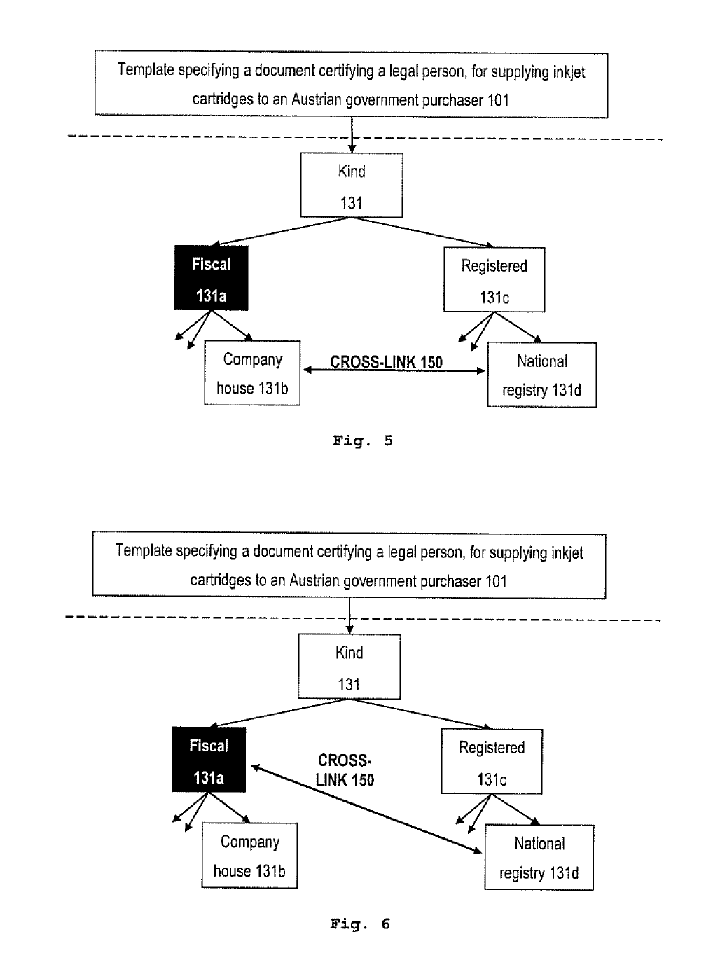

FIG. 4 shows a specific example in which it is clear how the dimensions can be hierarchical, wherein its dimension instances can be specified at any one of a plurality of levels in each dimension. In this case the document template specifying a document certifying a legal person, for supplying inkjet cartridges to an Austrian government purchaser 101, is specified as valid for Austria, in the German of Austria language, requiring a fiscally valid type document. The hierarchy denotes that e.g. a document valid for the EU will also be accepted as valid for Austria, but a document valid for Spain will not. A company house document will be accepted as a fiscal document, thus valid for this template. In some embodiments, a template may specify, or a document may apply to, more than one instance in each dimension, for example, if a document applies to a number of specific countries or is bilingual.

FIG. 5 shows how two dimensions can be linked by a cross-link 150 data structure such that two dimension instances are deemed equivalent.

FIG. 6 shows how such a cross-link 150 may connect instances of the same dimension, or for that matter, different dimensions at any hierarchical level. In this case, a fiscal document 131a is deemed equivalent to a national registry registered document 131d, such that a company house document 131b, any fiscal document 131a, or a national registry registered document 131d are valid for this template; but registered documents 131c other than a national registry registered document 131d are not valid document matches for this template.

FIG. 7 shows a document data structure is matched 310, 320, 330 against a document template, at each of their respective dimensions.

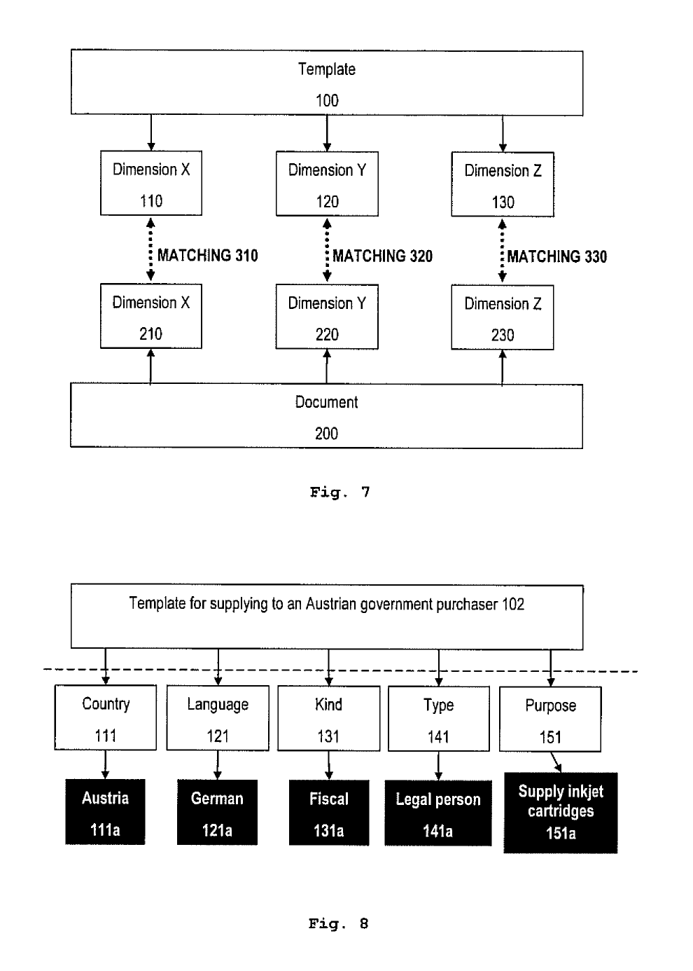

FIG. 8 shows a specific document template example in which hierarchies are not shown for clarity purposes.

FIG. 9 shows a specific document template example in which all template data, e.g. purpose or receiving entity, is coded as dimensions, thus enabling a more generic approach, whereby any document can be matched to any template, provided their dimension instances match.

Another field that can be used in a dimension is the emitter entity as previously mentioned. In some circumstances this will be enough to determine the kind and/or type of a document. It may happen that a specific emitter may issue more than one kind and/or more than one type of documents, which means that the kind and/or type dimensions may be required in the template.

It must be noted the country for which the document has been issued does not have to be the same as the emitter or receiver entities' countries. For example, a Spanish buyer may open a tender for providing construction services in France, thus requiring that an Italian bidder will need to produce a document which is considered valid in France.

These fields/dimensions are described as exemplary for the system and method embodiments described. It is clear that these may vary in number, quality or both.

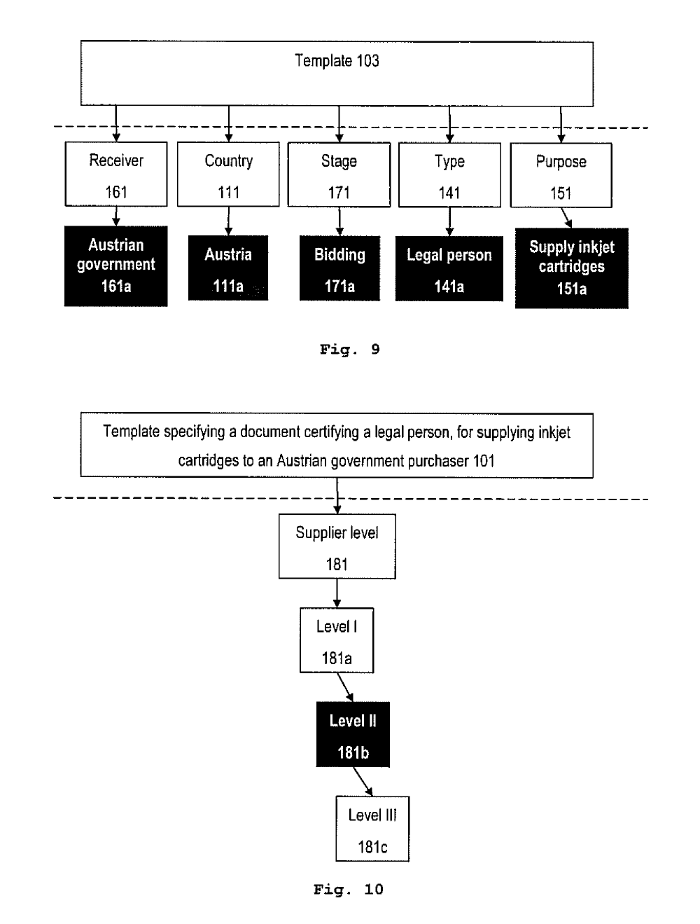

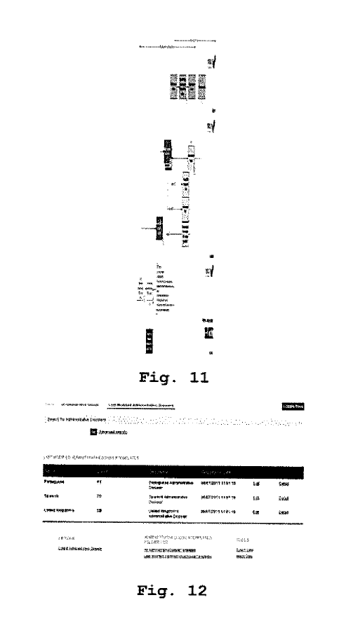

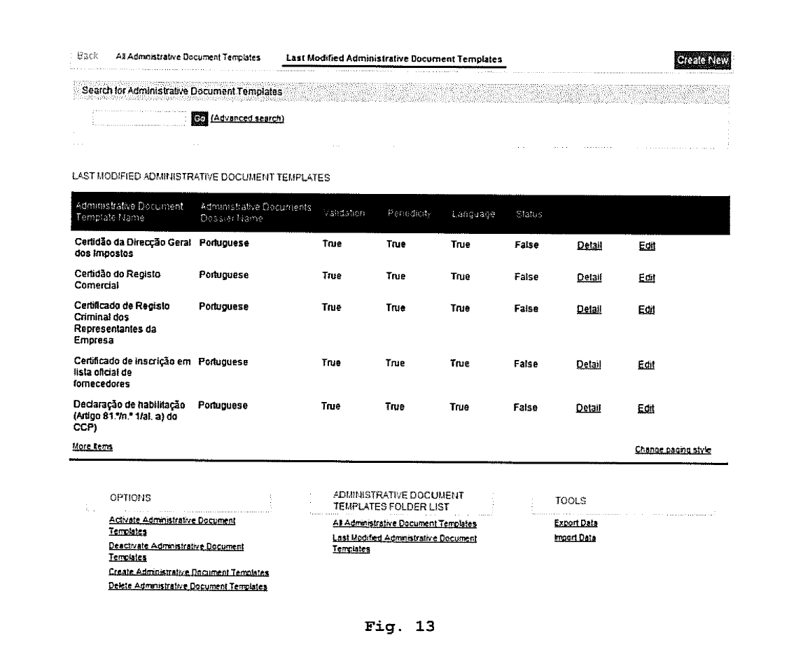

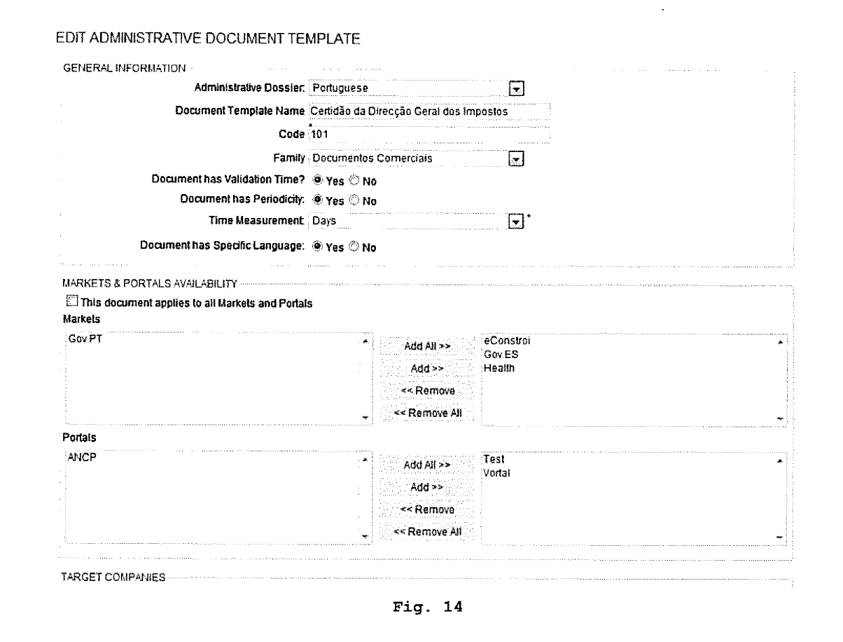

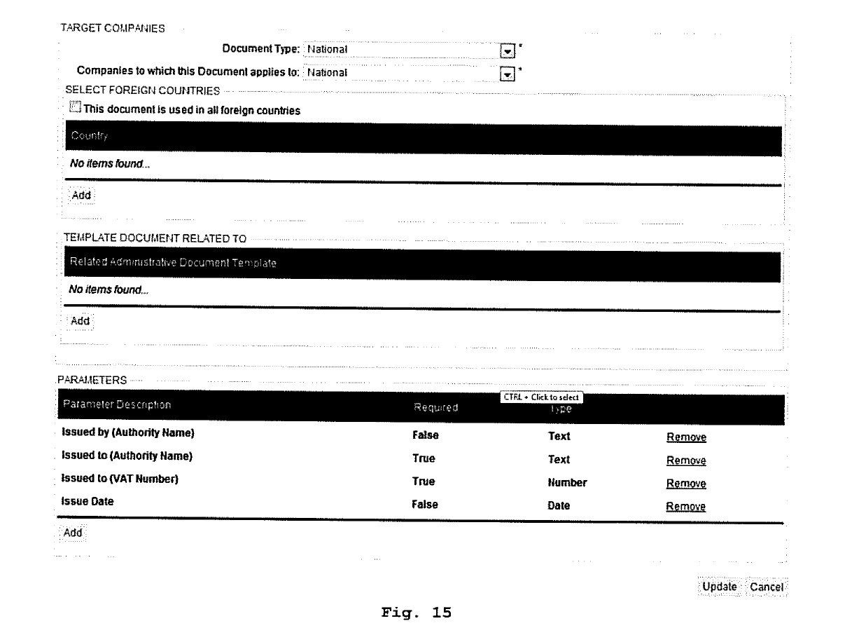

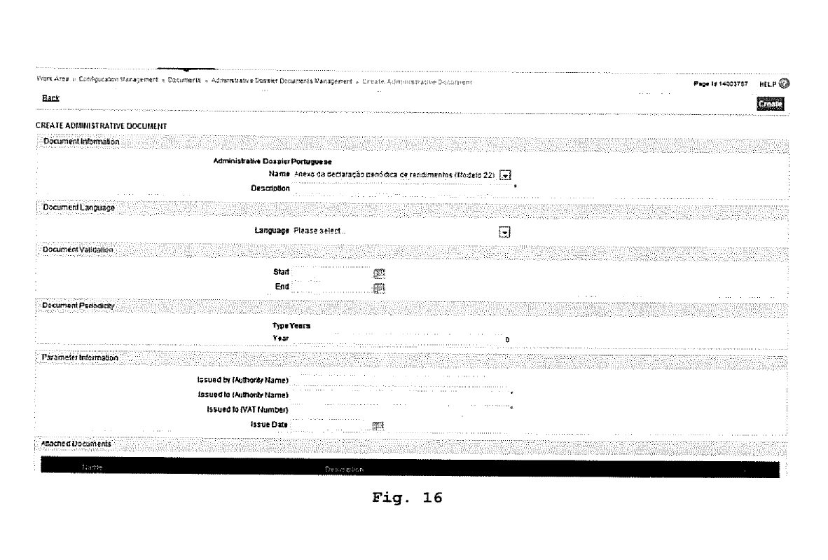

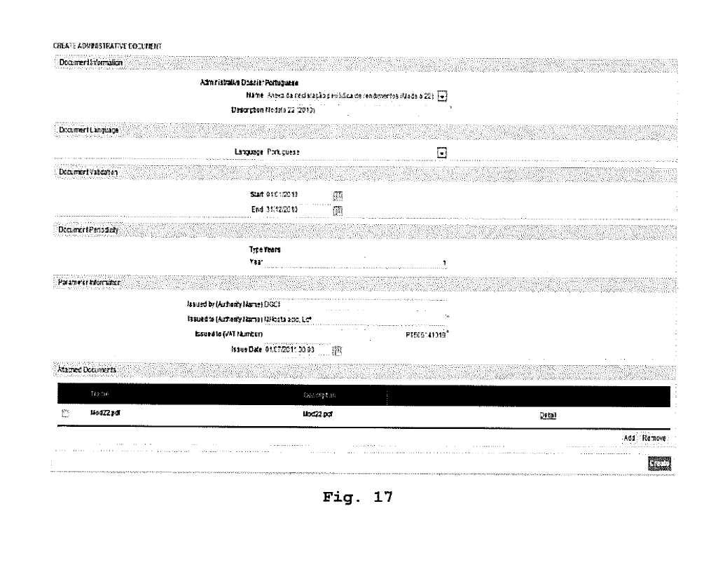

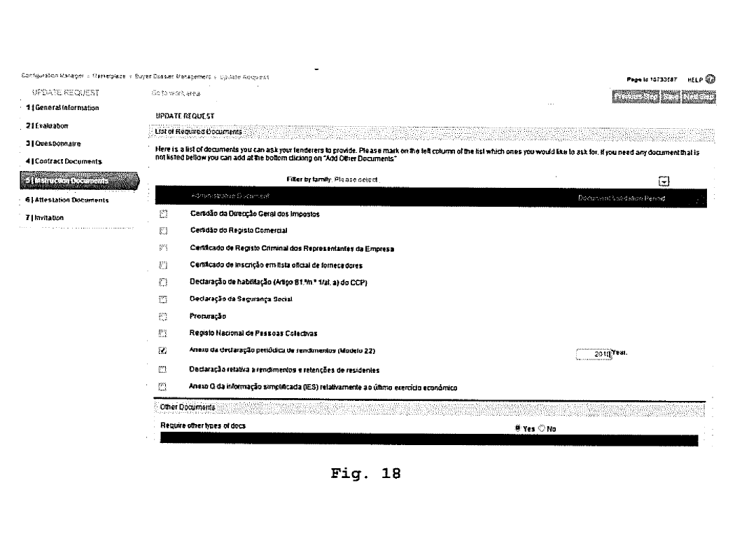

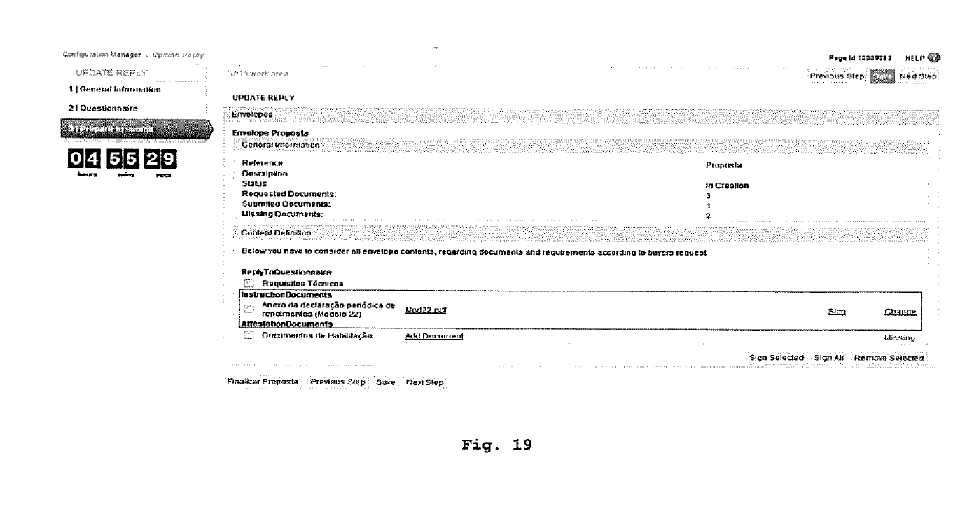

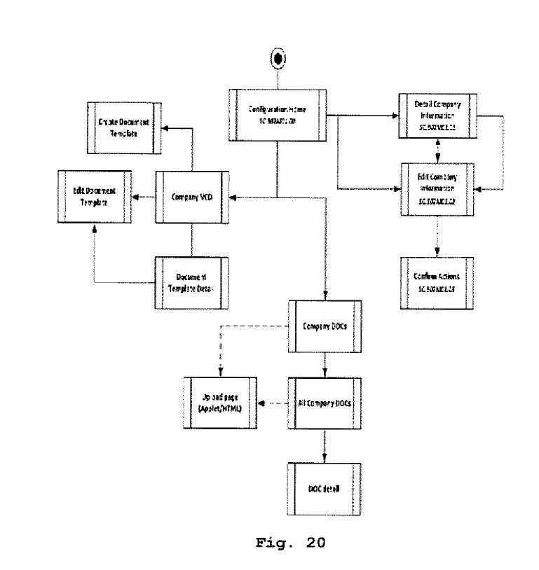

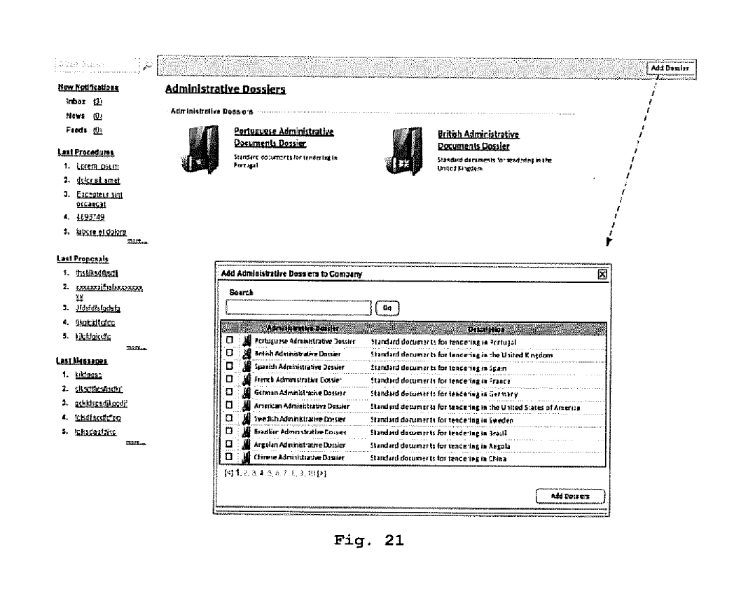

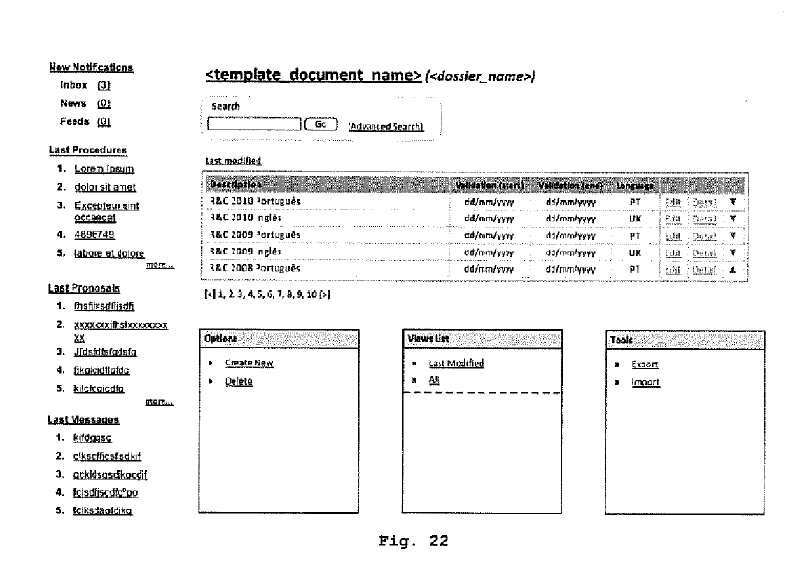

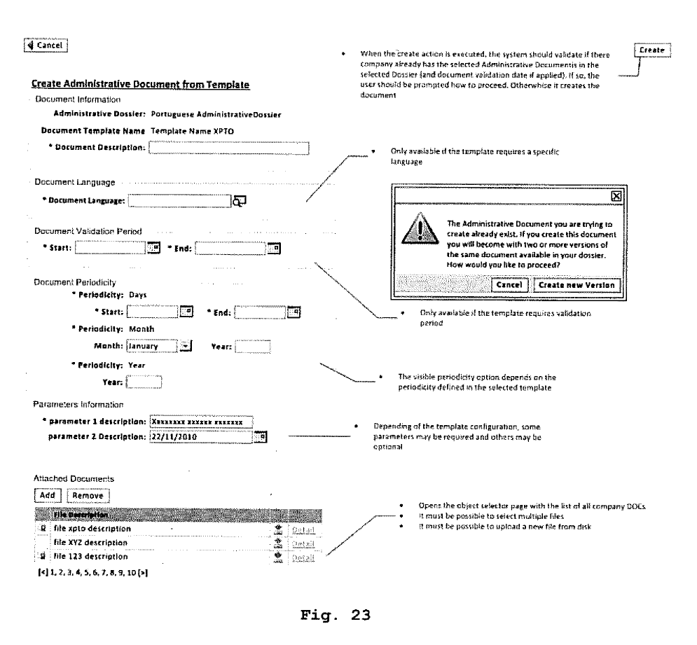

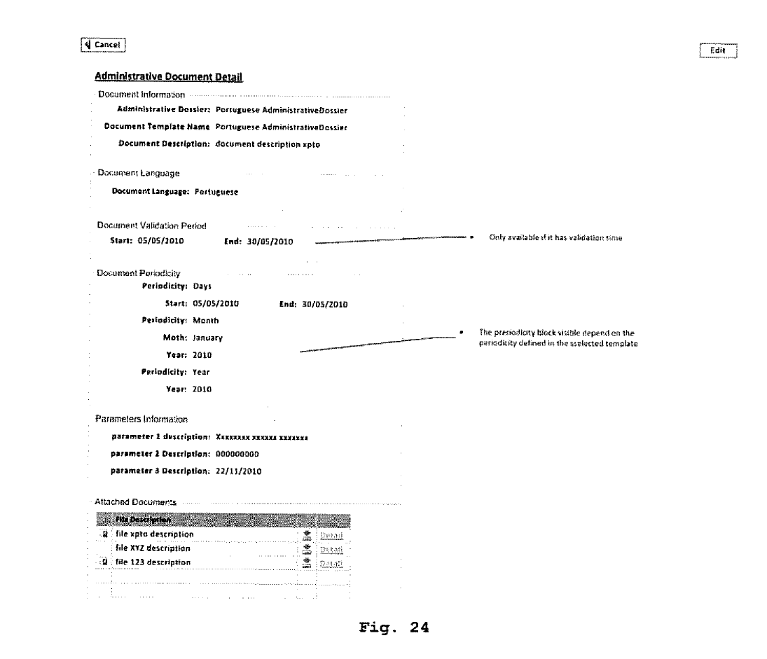

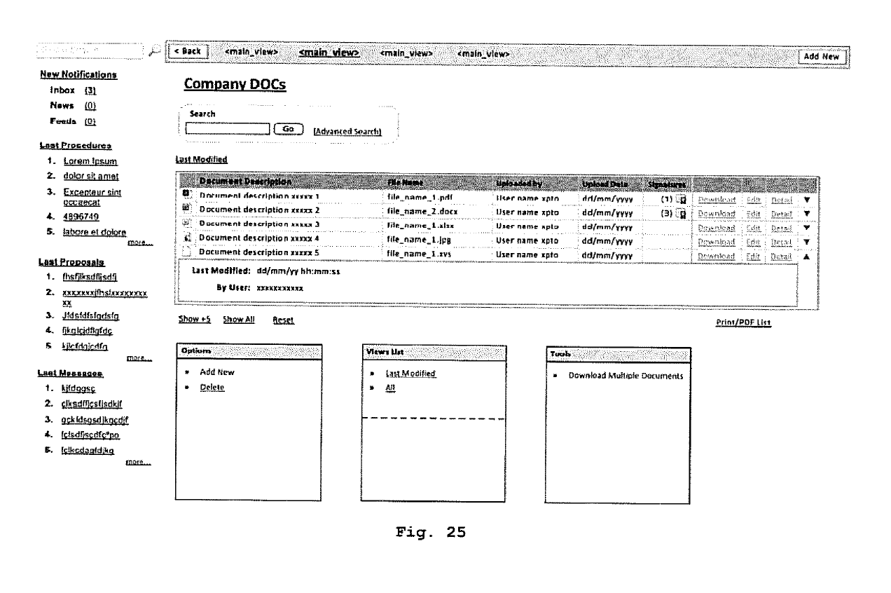

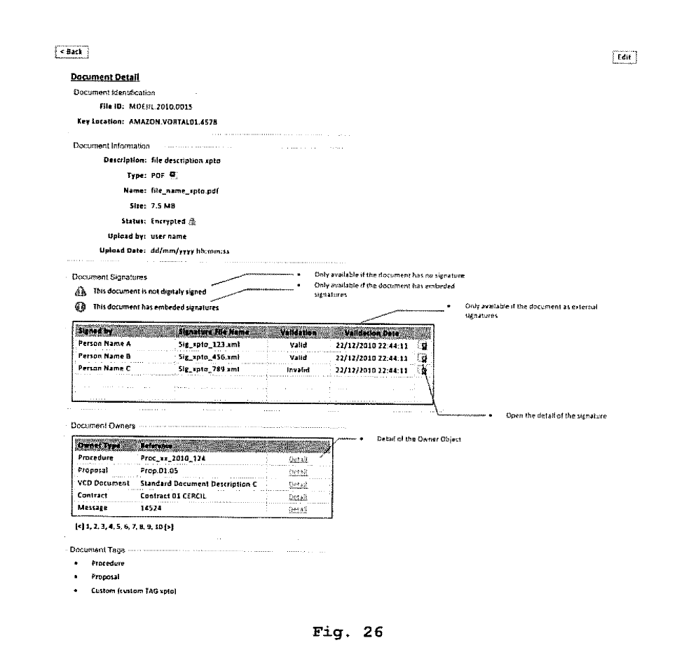

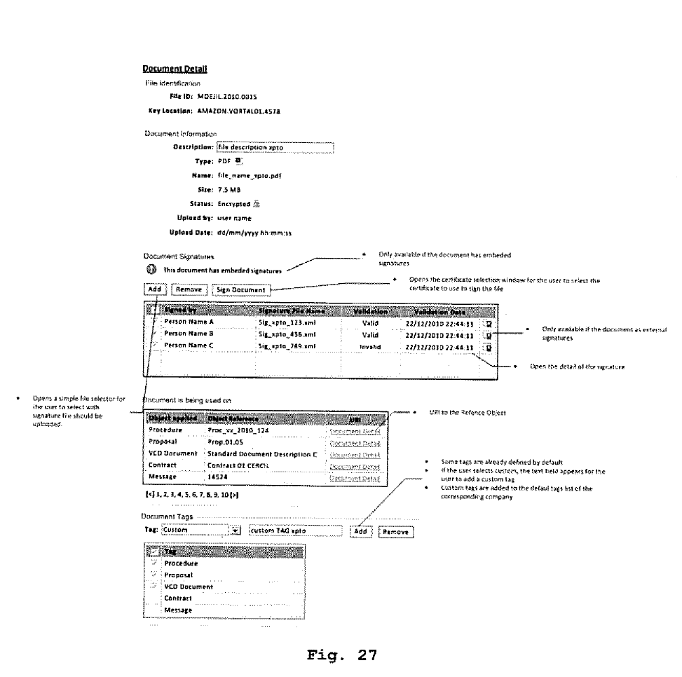

FIG. 10 shows how a buyer may specify a template requiring a field where adequateness levels are appropriate. FIG. 10 shows how the template dimension hierarchy can easily code different requisite levels, e.g. a supplier level of adequacy, such as a building permit level, in order to comply to real situations where compliance with a level presupposes compliance with lower, but not upper, levels.

When a tender is created by a buyer, one or more templates may be specified as setting the documents required from the bidders. These templates can be grouped in a tender “dossier”, which comprises from the buyer side the template or templates specified, and from the bidder side the documents supplied.

Specific procedures for operating embodiments comprise the following processes.

In a back-office part of the system, the manager of the system platform:
Runs in background a process of benchmarking and collection of legal documents, administrative, technical and financial resources that are typically used in each country/specialty. This is a continuous process of adaptation, according to the legislation produced and tenders that are being executed.
Based on this process, the system then offers Dossiers Administrative Documentation for each country/specialty.
Each of these dossiers consists of Document Templates, organized into “families” (legal, financial, technical, administrative, etc.).
Each of these templates document describes the main properties of the document inherent to each template:
   name of the document;
   who is the issuer;
   what the countries/regions apply;
   if there are, what other document in other countries/regions to which it is equivalent;
   the entities that apply (only entities in the country/region where it is issued only to entities outside the country/region where it is issued, both);
   the languages in which the document is issued and accepted;
   If the document has a time-dependent validity and its details [e.g. grace period applies for validity, pre-validation period, is there and what is the frequency (annual, monthly, daily, . . . ), actual validity period]
   If the document has a time-dependent validity, what are the start date and end date of validity
   If the document is online, what is the URL [e.g. simple link or web service validation URL] where it is available for consultation and/or validity verification;
   A further set of fields to identify characteristics suitable for each specific template.

This process may comprise integration and/or interfacing with the systems of the administrative bodies responsible for issuing and management of different documents, so they can proceed with the creation/update/delete types of documents that are available. Alternatively, the process has no such interface or integration, simply the document management is done by the system and its operators.

In terms of the users of the system, namely purchasing process buyers:
In each procedure that is created for public or third party availability, where it is applicable to request for qualification documents/qualification of bidders, the system suggests the Dossier Templates which fit best to the query in question and, consequently, which documents should be requested and allows the user to change this suggested selection.
When listing the requisite documents, the buyer can set the period for which it is permitted to receive the respective validating documents.
The buyer can also set the time period in which to receive documents (e.g. with the proposal and/or with the purchase award), indicating the cases where it is later required to present the document [e.g. true/false, time limit] and physical state [e.g. accepted online or needed in paper copy], specifying the cases in which all bidders have to present documents or only those who actually were selected for the award of the purchase.
The system allows the buyer to add any private information it considers relevant on each of the documents for each particular query (e.g. notes on the documents).

In terms of the users of the system, namely purchasing process bidders, or suppliers, two options are possible whether a specific request for quote/purchase already exists.
In the context of a proactive offer (not in the context of a specific buyer request):
Enabling the dossier or dossiers of document templates to use.
Filling in the template(s), and associating each document template to the bidder/supplier own corresponding document. The bidder/supplier may associate more than one document to each template, where variants are provided or required (language, timeliness, validity, . . . )
Updating the documents as necessary.

The system may proactively alert to the expiry of documents which have an expiry date set.
In the context of a purchasing procedure (a specific buyer request for quote or purchase already exists):
The system automatically activating the corresponding dossier templates to the specific request for quote or purchase.
Automatically associating of bidder/supplier own corresponding documents to the document template(s), thus attempting matching the documents requested by the buyer (match document template).

Despite the previous automatic association, the supplier has the option to manually change/insert/remove the document that is associated.

In case the requested document exists, but is not fully compatible with the request of the buyer (the class of license is different, the validity period does not match, the language of the document is not the required language, . . . ), the system may alert the user, before, during, or after making any association of the document with the proposal template.

If the document requested does not exist, but there is one that the system recognizes as being equivalent, the user is alerted and questions about whether it should be used in the purchase proposal.

For the documents that the system could not make the association, the system prompts the user to load these documents. By associating the missing document to the proposal template, as this association denotes a connection of the specific document to a particular document template, by the next purchasing procedure in which such document is requested in such a template, the document will then be readily available. That is, the document is not only uploaded for the availability in the current purchasing proposal, but it is also uploaded for future purchasing proposals already matched to dossier template(s), thus enabling automatic matching in those future purchasing proposals.

What is claimed is:

1. System that validates documents in hierarchical cross-linked purpose comprising:
a. document dossier module;
b. document template dossier module;
c. document template matcher module;
wherein the document and document templates are data structures comprising dimension data fields specifying the validity scope of said document or document template.

2. Process of hierarchical cross-linked purpose validating of documents in a system comprising:
a. receiving one or more document templates from a buyer;
b. selecting one or more document templates by associating said one or more document templates from the buyer with a specific purchasing process;
c. receiving, from the bidder or bidders of the purchasing process, one or more documents for validity verification against the one or more selected document templates;
d. matching one or more documents received from the bidder or bidders with the one or more selected document templates.

3. A process according to claim 2, wherein the step of selecting one or more document templates by associating said one or more document templates from the buyer with a specific purchasing process, comprises the step:
retrieving information from at least one PDF file comprising a structured character string represented with a font color equal to the background.

4. Process according to claim 3, wherein the structured character string is represented with a font height of at most 3 points.

5. Process according to claim 3, wherein the structured character string is placed in the beginning of the PDF file content.

6. Process according to claim 3, wherein the structured character string implements a tree structure and comprises at least one node label replacement.

7. Process according to claim 6, wherein root node comprises an attribute with the at least one node label replacement.

8. Process according to claim 4, wherein the structured character string is placed in the beginning of the PDF file content.

9. Process according to claim 4, wherein the structured character string implements a tree structure and comprises at least one node label replacement.

10. Process according to claim 5, wherein the structured character string implements a tree structure and comprises at least one node label replacement.
